(19) United States
(12) Patent Application Publication
(10) Pub. No.: US 2026/0101251 A1
(43) Pub. Date: Apr. 9, 2026

(54) METHODS AND APPARATUSES FOR TA ACQUISITION FAILURE AND PREAMBLE TRANSMISSION COLLISION

(71) Applicant: LENOVO (BEIJING) LIMITED, Beijing (CN)

(72) Inventors: Lianhai Wu, Beijing (CN); Mingzeng Dai, Shanghai (CN); Bingchao Liu, Beijing (CN)

(21) Appl. No.: 19/113,027

(22) PCT Filed: Dec. 20, 2022
(86) PCT No.: PCT/CN2022/140488

§ 371 Date: Mar. 19, 2025

(51) Int. Cl. H04W 36/08; H04W 36/00; H04W 56/00; H04W 74/0833

(52) U.S. Cl. CPC H04W 36/08; H04W 36/0058; H04W 56/0045; H04W 74/0833

(57) ABSTRACT

Embodiments of the present application relate to methods and apparatuses for lower layer-based mobility with timing advance (TA) acquisition failure and preamble transmission collision under a 3rd Generation Partnership Project (3GPP) 5G system or the like. According to an embodiment of the present application, a candidate distributed unit (DU) of a base station (BS) includes a transceiver and a processor coupled to the transceiver, and the processor is configured to cause the candidate DU to: receive a request of a cell switching procedure associated with a candidate cell from a centralized unit (CU) of the BS; and transmit a response including configuration information associated with the candidate cell to the CU based on the request.

### TECHNICAL FIELD

Embodiments of the present application generally relate to wireless communication technology, especially to methods and apparatuses for lower layer-based mobility with timing advance (TA) acquisition failure and preamble transmission collision.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Currently, details regarding TA acquisition failure and preamble transmission collision in a lower layer-based mobility case have not been discussed in 3GPP 5G technology yet.

### SUMMARY

Some embodiments of the present application provide a user equipment (UE). The UE includes a transceiver and a processor coupled to the transceiver; and the processor is configured to cause the UE to: receive radio resource control (RRC) configuration information associated with one or more candidate cells related to a cell switching procedure; and receive a first indication to trigger a timing advance (TA) acquisition procedure or a TA re-acquisition procedure to a first candidate cell within the one or more candidate cells before performing the cell switching procedure.

In the embodiments of the present application, TA acquisition or early TA acquisition means that the UE is expected to perform a TA acquisition procedure before a cell switching procedure. TA re-acquisition or early TA re-acquisition means that the UE is expected to perform a TA re-acquisition procedure before a cell switching procedure. TA acquisition, early TA acquisition, TA re-acquisition, or early TA re-acquisition may be triggered by the reception of an indication from the serving BS, e.g., a physical downlink control channel (PDCCH) order which is downlink control information (DCI).

In some embodiments of the present application, the processor is configured to cause the UE to: determine whether a collision happens between an uplink (UL) transmission in a serving cell of the UE and a random access channel occasion (RO) in a candidate cell within the one or more candidate cells, wherein the RO is associated with the TA acquisition procedure or the TA re-acquisition procedure; and in response to the collision, perform the TA acquisition procedure or the TA re-acquisition procedure associated with the RO.

In some embodiments of the present application, if the first indication is received while the UE is initiating a first random access (RA) procedure in a serving cell, the processor is configured to cause the UE to: perform a second RA procedure for the TA acquisition procedure or the TA re-acquisition procedure; or suspend the first RA procedure.

In some embodiments of the present application, the processor is configured to cause the UE to continue to perform the suspended first RA procedure after completing the second RA procedure.

In some embodiments of the present application, the processor is configured to cause the UE to transmit a first preamble for the TA acquisition procedure or the TA re-acquisition procedure to the first candidate cell once or several times based on the RRC configuration information.

In some embodiments of the present application, the processor is configured to cause the UE to: receive a second indication for the TA re-acquisition procedure associated with the first candidate cell; and transmit a second preamble for the TA re-acquisition procedure associated with the first candidate cell with higher power than the first preamble.

In some embodiments of the present application, in response to failing to receive a TA value after transmitting the first preamble, the processor is configured to cause the UE to transmit failure information to a source distributed unit (DU) of a base station (BS) or to a centralized unit (CU) of the BS via the source DU.

Some embodiments of the present application provide a candidate distributed unit (DU) of a base station (BS). The candidate DU includes a transceiver and a processor coupled to the transceiver; and the processor is configured to cause the candidate DU to: receive a request of a cell switching procedure associated with a candidate cell from a centralized unit (CU) of the BS; and transmit a response including configuration information associated with the candidate cell to the CU based on the request.

In some embodiments of the present application, the processor is configured to cause the candidate DU to: receive a preamble for a timing advance (TA) acquisition procedure or a TA re-acquisition procedure; calculate a TA value based on the received preamble; and transmit at least one of the TA value, identifier (ID) information of the candidate cell, or ID information of a user equipment (UE) to the CU.

In some embodiments of the present application, the processor is configured to cause the candidate DU to receive at least one of the following from the CU: a first indication for indicating a failure of a TA acquisition procedure or a TA re-acquisition procedure; a request of random access channel (RACH) configuration information for the TA acquisition procedure or the TA re-acquisition procedure; or a measurement result of a user equipment (UE).

In some embodiments of the present application, in response to failing to receive a preamble for a TA acquisition procedure or a TA re-acquisition procedure in a RACH occasion (RO), the processor is configured to cause the candidate DU to determine a failure of the TA acquisition procedure or the TA re-acquisition procedure.

In some embodiments of the present application, in response to receiving the first indication from the CU or in response to determining the failure of the TA acquisition procedure or the TA re-acquisition procedure, the processor is configured to cause the candidate DU to transmit a first message to the CU, wherein the first message includes at least one of the following: identifier (ID) information of a candidate cell associated with the TA acquisition procedure or the TA re-acquisition procedure; ID information of the UE; a second indication for indicating the failure of the TA acquisition procedure or the TA re-acquisition procedure; a request of a measurement result of the UE; a third indication for indicating the TA re-acquisition procedure; or the RACH configuration information for the TA acquisition procedure or the TA re-acquisition procedure.

In some embodiments of the present application, the response includes a random access channel (RACH) resource for a timing advance (TA) acquisition procedure, and the RACH resource includes a preamble or a RACH occasion (RO).

Some embodiments of the present application provide a centralized unit (CU) of a base station (BS). The CU includes a transceiver and a processor coupled to the transceiver; and the processor is configured to cause the CU to: transmit a request to a candidate distributed unit (DU) of the BS, wherein the request includes identifier (ID) information of one or more candidate cells; receive a response corresponding to the request from the candidate DU, wherein the response is associated with a cell switching procedure; and transmit first configuration information to a user equipment (UE) via a source DU of the BS based on the response.

In some embodiments of the present application, the processor is configured to cause the CU to receive second configuration information including at least one of the following from the candidate DU: a timing advance (TA) value calculated for a TA acquisition procedure or a TA re-acquisition procedure; ID information of a candidate cell associated with the TA acquisition procedure or the TA re-acquisition procedure; ID information of the UE; a first indication for indicating the failure of the TA acquisition procedure or the TA re-acquisition procedure; a request of a measurement result of the UE; a second indication for indicating the TA re-acquisition procedure; or random access channel (RACH) configuration information for the TA re-acquisition procedure.

In some embodiments of the present application, after receiving the second configuration information from the candidate DU, the processor is configured to cause the CU to transmit the second configuration information to the source DU.

In some embodiments of the present application, the processor is configured to cause the CU to receive second information from the source DU, and wherein the second information includes at least one of the following: a third indication for indicating a failure of a TA acquisition procedure or a TA re-acquisition procedure; ID information of a candidate cell associated with the TA acquisition procedure or the TA re-acquisition procedure; or a Layer 1 measurement result of the UE.

In some embodiments of the present application, the second information is received by the source DU from the UE.

In some embodiments of the present application, the processor is configured to cause the CU to transmit at least one of the following to the candidate DU: a fourth indication for indicating the failure of the TA acquisition procedure or the TA re-acquisition procedure; or the Layer 1 measurement result of the UE.

In some embodiments of the present application, the processor is configured to cause the CU to: receive failure information related to a TA acquisition procedure or a TA re-acquisition procedure from the UE; and transmit at least one of the following to the candidate DU: a fifth indication for indicating a failure of the TA acquisition procedure or the TA re-acquisition procedure; or a request of random access channel (RACH) configuration information for the TA acquisition procedure or the TA re-acquisition procedure.

Some embodiments of the present application provide a source distributed unit (DU) of a base station (BS). The source DU includes a transceiver and a processor coupled to the transceiver; and the processor is configured to cause the source DU to: receive first configuration information associated with one or more candidate cells related to a cell switching procedure from a centralized unit (CU) of the BS; transmit second configuration information to a user equipment (UE) based on the first configuration information received from the CU; and transmit a first indication to trigger a timing advance (TA) acquisition procedure or a TA re-acquisition procedure to a first candidate cell within the one or more candidate cells before performing the cell switching procedure to the UE.

In some embodiments of the present application, the first indication is included in downlink control information (DCI).

In some embodiments of the present application, the first configuration information includes at least one of the following: a TA value calculated for the TA acquisition procedure or the TA re-acquisition procedure; identifier (ID) information of the first candidate cell; ID information of the UE; a second indication for indicating the TA re-acquisition procedure; or random access channel (RACH) configuration information for the TA re-acquisition procedure.

In some embodiments of the present application, if the first configuration information includes at least one of the second indication or the RACH configuration information for the TA re-acquisition procedure, the processor is configured to cause the source DU to transmit a third indication to trigger the TA re-acquisition procedure to a candidate DU of the BS.

In some embodiments of the present application, the first configuration information is generated by the candidate DU and then transmitted to the CU.

In some embodiments of the present application, the processor is configured to cause the source DU to: determine whether a TA value is received from a candidate DU of the BS or not within a time period; and in response to determining that the TA value is not received within the time period, determine that the TA acquisition procedure or the TA re-acquisition procedure is failed.

In some embodiments of the present application, the processor is configured to cause the source DU to: start a timer related to the TA value; and determine that the TA value is not received within the time period upon expiry of the timer.

In some embodiments of the present application, the timer is started upon transmitting downlink control information (DCI) for the TA acquisition procedure or the TA re-acquisition procedure, or the timer is started in a random access channel occasion (RO).

In some embodiments of the present application, the processor is configured to cause the source DU to receive failure information regarding failing to acquire a TA value from the UE.

In some embodiments of the present application, in response to determining that the TA acquisition procedure or the TA re-acquisition procedure is failed or in response to receiving the failure information, the processor is configured to cause the source DU to transmit at least one of the following to the CU: a fourth indication for indicating failing to acquire the TA value; ID information of the first candidate cell; or a Layer 1 measurement result of the UE.

In some embodiments of the present application, the processor is configured to cause the source DU to receive first information from the UE, and wherein the first information includes at least one of the following: a fifth indication for indicating a failure of the TA acquisition procedure or the TA re-acquisition procedure; ID information of the first candidate cell; or a Layer 1 measurement result of the UE.

In some embodiments of the present application, the processor is configured to cause the source DU to transmit the first information to the CU.

Some embodiments of the present application provide a method performed by a UE. The method includes: receiving radio resource control (RRC) configuration information associated with one or more candidate cells related to a cell switching procedure; and receiving a first indication to trigger a timing advance (TA) acquisition procedure or a TA re-acquisition procedure to a first candidate cell within the one or more candidate cells before performing the cell switching procedure.

Some embodiments of the present application provide a method performed by a candidate distributed unit (DU) of a base station (BS). The method includes: receiving a request of a cell switching procedure associated with a candidate cell from a centralized unit (CU) of the BS; and transmitting a response including configuration information associated with the candidate cell to the CU based on the request.

Some embodiments of the present application provide a method performed by a centralized unit (CU) of a base station (BS). The method includes: transmitting a request to a candidate distributed unit (DU) of the BS, wherein the request includes identifier (ID) information of one or more candidate cells; and receiving a response corresponding to the request from the candidate DU, wherein the response is associated with a cell switching procedure; and transmitting first configuration information to a user equipment (UE) via a source DU of the BS based on the response.

Some embodiments of the present application provide a method performed by a source distributed unit (DU) of a base station (BS). The method includes: receiving first configuration information associated with one or more candidate cells related to a cell switching procedure from a centralized unit (CU) of the BS; transmitting second configuration information to a user equipment (UE) based on the first configuration information received from the CU; and transmitting a first indication to trigger a timing advance (TA) acquisition procedure or a TA re-acquisition procedure to a first candidate cell within the one or more candidate cells before performing the cell switching procedure to the UE.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (e.g., a base station (BS), a CU, or a DU).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present application.

FIG. 2 illustrates a schematic diagram of inter-cell Layer1/Layer2 (L1/L2) mobility in accordance with some embodiments of the present application.

FIGS. 3-6 illustrate exemplary flowcharts associated with a cell switching procedure in accordance with some embodiments of the present application.

FIGS. 7-10 illustrate exemplary flowcharts of performing a cell switching procedure in accordance with some embodiments of the present application.

FIG. 11 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

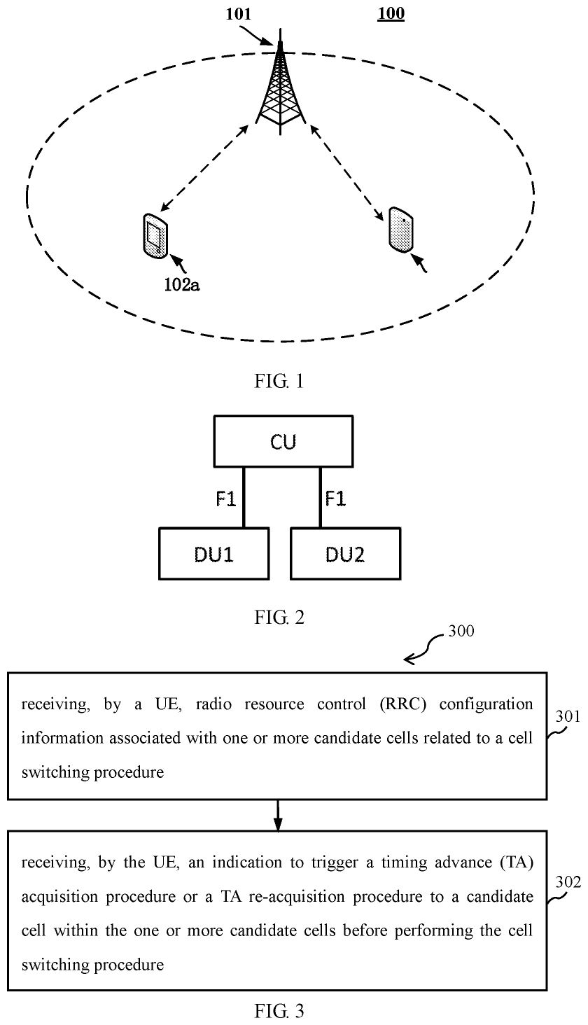

FIG. 1 illustrates a schematic diagram of a wireless communication system according to some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g., UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

UE 102, e.g., UE 102a and UE 102b, should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

In 3GPP Release 18, it has been discussed to support an inter-cell mobility based on Layer1/Layer2 (L1/L2) signaling. In particular, a UE can be provided in advance with configurations from multiple cells, and a BS (e.g., gNB) may switch a UE to a new cell using L1/L2 signaling taking into account the received physical layer measurement result. In accordance with 3GPP standard documents, a BS may consist of a BS-centralized unit (CU) and one or more BS-distributed unit(s) (DU(s)). A BS-CU and a BS-DU are connected via an F1 interface which is a logical interface. One BS-DU is connected to only one BS-CU.

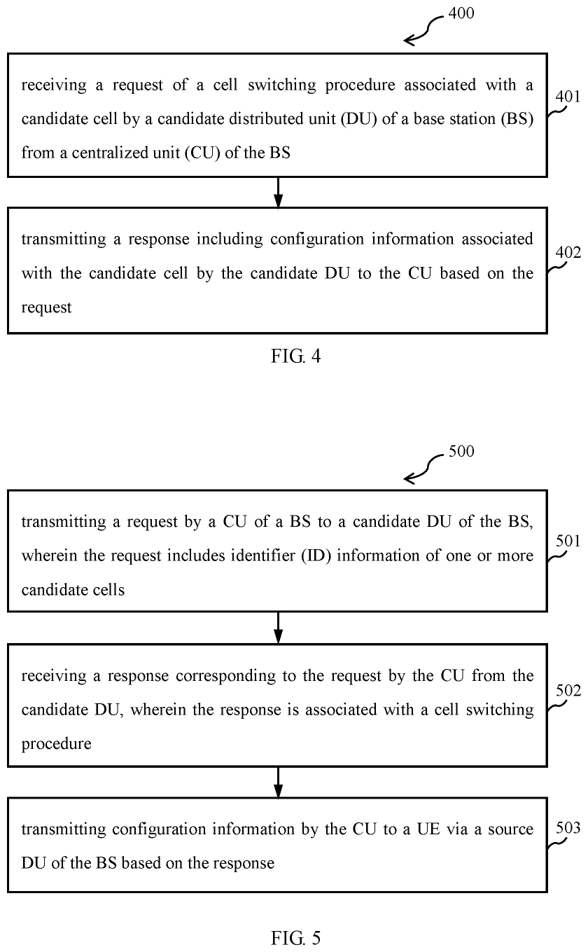

FIG. 2 illustrates a schematic diagram of inter-cell Layer1/Layer2 (L1/L2) mobility in accordance with some embodiments of the present application. As shown in FIG. 2, CU may communicate with two DUs, i.e., DU1 or DU2, via F1 interfaces. CU in FIG. 2 may implement legacy mobility decision based on Layer 3 (L3) measurement result. DU1 or DU2 in FIG. 2 may implement L1/L2 mobility decision based on physical layer measurement result(s).

Compared to legacy L3 mobility, L1/L2 mobility is considered faster with less processing delay and signaling delay. In legacy L3 mobility, a CU (e.g., CU as shown in FIG. 2) makes the mobility decision based on received radio resource management (RRM) measurement report. Different than legacy L3 mobility, in L1/L2 mobility, a DU (e.g., DU1 or DU2 as shown in FIG. 2) makes the mobility decision based on physical layer measurement result, e.g., carried in a channel state information (CSI) report. Besides, in legacy L3 mobility, the handover command is sent via RRC signalling from the SN CU to a UE, while in L1/L2 mobility, the “handover” command is sent via L1/L2 signaling (e.g., downlink control information (DCI) or a medium access control (MAC) control element (CE)) from the DU to a UE. The “handover” command in L1/L2 mobility can be about cell activation or deactivation, e.g., activate a new serving PCell while deactivate the old serving PCell.

Currently, issues of a TA acquisition failure and preamble transmission collision in a lower layer-based mobility case have not been solved. Embodiments of the present application aim to solve such issues. For instance, in some embodiments of the present application, considering the case that “a random access response (RAR) is needed”, three potential options including candidate cell triggering, source cell triggering and CU triggering TA re-acquisition are introduced, respectively. In some embodiments of the present application, considering the case that “a RAR is not needed” a UE based triggering TA re-acquisition is introduced. In some embodiments of the present application, after a UE receives a PDCCH order, the UE will transmit the preamble in the indicated RACH occasion (RO) of candidate cell. In some embodiments of the present application, an issue of how to handle the collision between uplink (UL) transmission in serving cell (e.g., a scheduling request (SR)) and a RO of a candidate cell is introduced. In some embodiments of the present application, when a UE receives a PDCCH order for trigger TA acquisition, the UE is initiating a RA procedure in a serving cell, e.g., UL is out of synchronization upon UL data arrival in the serving cell. In some embodiments of the present application, an issue of how to handle the collision between two RA procedures is studied.

In the embodiments of the present application, TA acquisition or early TA acquisition means that a UE is expected to perform a TA acquisition procedure before a cell switching procedure. TA re-acquisition or early TA re-acquisition means that the UE is expected to perform a TA re-acquisition procedure before a cell switching procedure. TA acquisition, early TA acquisition, TA re-acquisition, or early TA re-acquisition may be triggered by the reception of an indication from the serving BS, e.g., a PDCCH order which is DCI.

Some embodiments of the present application may be applicable for a case of “lower layer triggered mobility” or “L1/L2 triggered mobility”, and the abbreviation of at least one of them may be “LTM”. In an LTM case, a UE may access a serving BS (e.g., a serving gNB). The UE may report Layer3 (L3) measurement result(s) based on the configuration from the serving gNB. If the serving gNB, e.g., a CU of the serving gNB, decides to switch the UE to a candidate cell based on the measurement result(s), the serving gNB may request target DU(s) to prepare the configuration for one or more candidate cells. After receiving the candidate cell configuration from a target DU of the serving gNB, the serving gNB may transmit an RRC reconfiguration message including ID information of one or more candidate cells to the UE. For example, the CU may transmit the RRC reconfiguration message to the UE via a source DU of the serving gNB. The UE may transmit an RRC reconfiguration complete message to the serving gNB (e.g., CU) via the source DU. The UE may ensure UL synchronization or DL synchronization before receiving a cell switch command. For example, the UE may get or acquire a TA value via a random access (RA) or preamble transmission. The UE may report Layer1 (L1) measurement result(s) for a dynamic switching purpose. The serving gNB, e.g., the source DU, may transmit a cell switch command, e.g., a MAC CE or DCI. The UE can apply the RRC reconfiguration message and start a timer upon receiving the lower layer command.

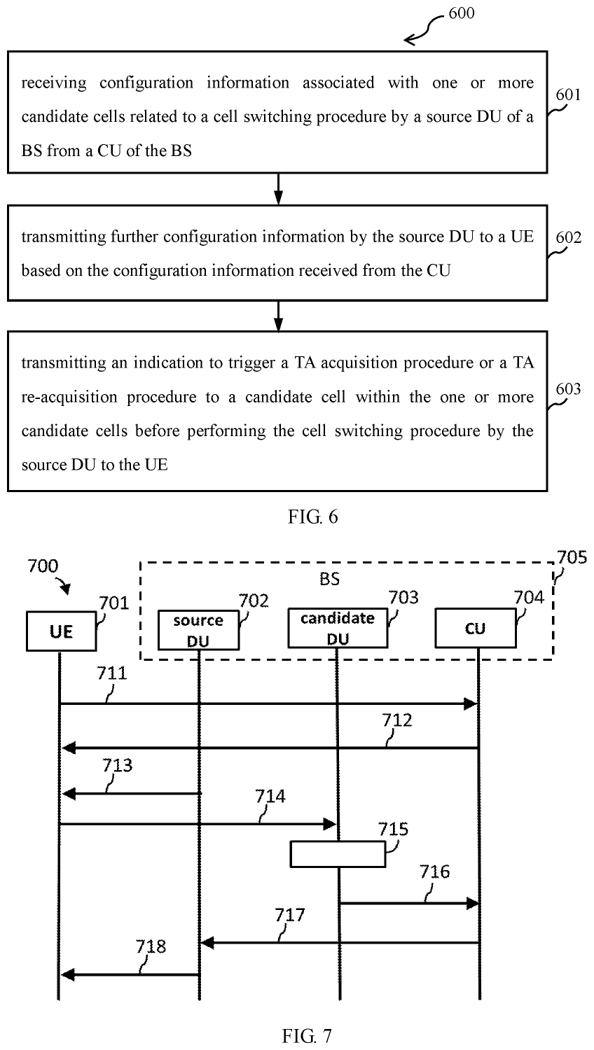

In particular, in embodiments of FIGS. 3-11 of the present application, both inter-DU mobility scenario and intra-DU mobility scenario are considered, e.g., inter-gNB-DU LTM or intra-gNB-DU LTM. Inter-DU mobility means that a connection to a CU remains the same, while a UE may change from a source cell related to a source DU to a target cell related to a target DU due to mobility, while both the source DU and the target DU are managed by the CU. Intra-DU mobility means that a connection to a CU remains the same, while a UE may change from a source cell to a target cell related to the same DU due to mobility. More details will be illustrated in following text in combination with the appended drawings.

FIG. 3 illustrates yet another exemplary flowchart associated with a cell switching procedure in accordance with some embodiments of the present application. The exemplary flowchart 300 in the embodiments of FIG. 3 may be performed by a UE (e.g., UE 102 as shown and illustrated in FIG. 1). Although described with respect to a UE, it should be understood that other devices may be configured to perform a flowchart similar to that of FIG. 3. Details described in all other embodiments of the present application are applicable for the embodiments of FIG. 3. Moreover, details described in the embodiments of FIG. 3 are applicable for all the embodiments of FIGS. 1, 2, and 4-11.

In the exemplary flowchart 300 as shown in FIG. 3, in operation 301, a UE may receive RRC configuration information associated with one or more candidate cells related to a cell switching procedure. In operation 302 as shown in FIG. 3, the UE may receive an indication (denoted as indication #1 for simplicity) to trigger a TA acquisition procedure or a TA re-acquisition procedure to a candidate cell (denoted as candidate cell #1 for simplicity) within the one or more candidate cells before performing the cell switching procedure.

In some embodiments, the UE may determine whether a collision happens between “an UL transmission in a serving cell of the UE” and “a RO in a candidate cell within the one or more candidate cells”, wherein the RO is associated with the TA acquisition procedure or the TA re-acquisition procedure. If the UE determines that the collision happens, the UE may perform the TA acquisition procedure or the TA re-acquisition procedure associated with the RO.

In some embodiments, if indication #1 is received while the UE is initiating a RA procedure (denoted as RA procedure #1 for simplicity) in the serving cell of the UE, the UE may perform another RA procedure (denoted as RA procedure #2 for simplicity) for the TA acquisition procedure or the TA re-acquisition procedure, or suspend RA procedure #1. In an embodiment, the UE may continue to perform the suspended RA procedure #1 after completing RA procedure #2.

In some other embodiments, if indication #1 is received while the UE is initiating RA procedure #1, the UE may perform RA procedure #1 or suspend RA procedure #2. In an embodiment, the UE may continue to perform the suspended RA procedure #2 after completing RA procedure #1.

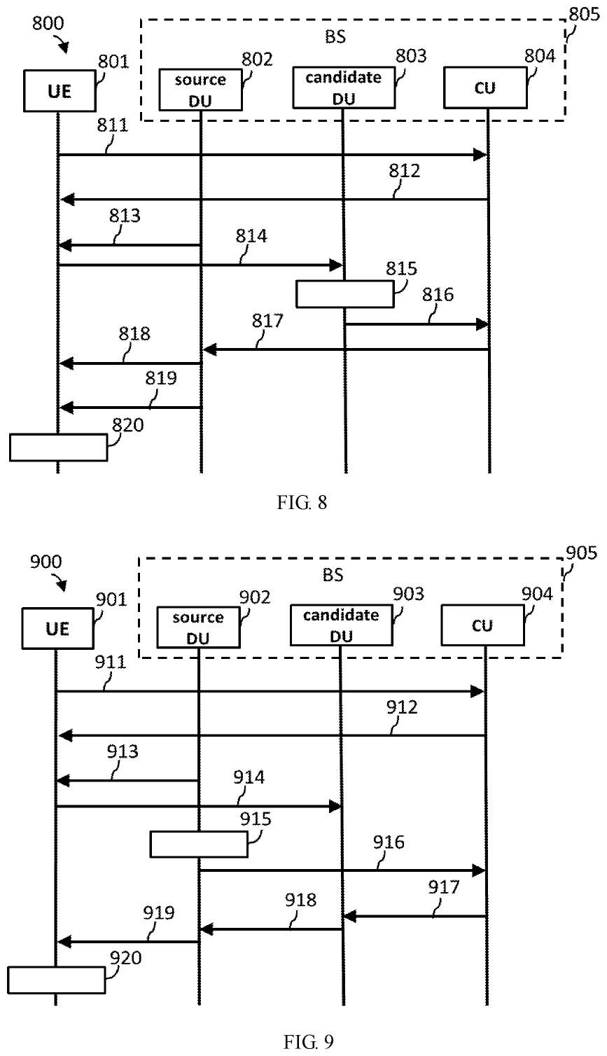

In some embodiments, based on the RRC configuration information received in operation 301, the UE may transmit a preamble (denoted as preamble #1 for simplicity) for the TA acquisition procedure or the TA re-acquisition procedure to candidate cell #1 once or several times. A specific example is described in the embodiments of FIG. 7 as follows.

In some embodiments, the UE may receive another indication (denoted as indication #2 for simplicity) for the TA re-acquisition procedure associated with candidate cell #1, and transmit another preamble for the TA re-acquisition procedure associated with candidate cell #1 with higher power than preamble #1.

In some embodiments, in response to failing to receive a TA value after transmitting preamble #1, the UE may transmit failure information to a source DU of a BS (e.g., DU2 as shown and illustrated in FIG. 2) or to a CU of the BS (e.g., CU as shown and illustrated in FIG. 2) via the source DU. A specific example is described in the embodiments of FIG. 10 as follows.

FIG. 4 illustrates an exemplary flowchart associated with a cell switching procedure in accordance with some embodiments of the present application. The exemplary flowchart 400 in the embodiments of FIG. 4 may be performed by a candidate DU (e.g., DU1 or DU2 as shown and illustrated in FIG. 2). A candidate DU may also be named as a target DU in some cases. Although described with respect to a candidate DU, it should be understood that other devices may be configured to perform a flowchart similar to that of FIG. 4. Details described in all other embodiments of the present application are applicable for the embodiments of FIG. 4. Moreover, details described in the embodiments of FIG. 4 are applicable for all the embodiments of FIGS. 1-3 and 5-11.

In the exemplary flowchart 400, in operation 401, a candidate DU of a BS (e.g., DU1 as shown and illustrated in FIG. 2) may receive a request of a cell switching procedure associated with a candidate cell from a CU of the BS (e.g., CU as shown and illustrated in FIG. 2).

In operation 402 as shown in FIG. 4, the candidate DU may transmit a response including configuration information associated with the candidate cell to the CU based on the request. In some embodiments, the response includes a RACH resource for a TA acquisition procedure, and the RACH resource includes a preamble or a RO.

In some embodiments, the candidate DU may, receive a preamble for a TA acquisition procedure or a TA re-acquisition procedure, calculate a TA value based on the received preamble, and transmit at least one of the following to the CU:
(1) the calculated TA value,
(2) ID information of the candidate cell (e.g., an index of the candidate cell), or
(3) ID information of a UE (e.g., UE 102 as shown and illustrated in FIG. 1). A specific example is described in the embodiments of FIG. 7 as follows.

In some embodiments, the candidate DU may receive at least one of the following from the CU:
(1) an indication (denoted as indication #3 for simplicity) for indicating a failure of a TA acquisition procedure or a TA re-acquisition procedure;
(2) a request of RACH configuration information for the TA acquisition procedure or the TA re-acquisition procedure; or
(3) a measurement result of the UE. A specific example is described in the embodiments of FIG. 9 as follows.

In some embodiments, in response to failing to receive a preamble for a TA acquisition procedure or a TA re-acquisition procedure in a RO, the candidate DU may determine a failure of the TA acquisition procedure or the TA re-acquisition procedure.

In some embodiments, in response to receiving indication #3 from the CU or in response to determining the failure of the TA acquisition procedure or the TA re-acquisition procedure, the candidate DU may transmit a message (denoted as message #1 for simplicity) to the CU. Message #1 may include at least one of the following:
(1) ID information (e.g., an index) of a candidate cell associated with the TA acquisition procedure or the TA re-acquisition procedure;
(2) ID information of the UE;
(3) an indication (denoted as indication #4 for simplicity) for indicating the failure of the TA acquisition procedure or the TA re-acquisition procedure;
(4) a request of a measurement result of the UE;
(5) an indication (denoted as indication #5 for simplicity) for indicating the TA re-acquisition procedure; or
(6) the RACH configuration information for the TA acquisition procedure or the TA re-acquisition procedure. A specific example is described in the embodiments of FIG. 8 as follows.

FIG. 5 illustrates a further exemplary flowchart associated with a cell switching procedure in accordance with some embodiments of the present application. The exemplary flowchart 500 in the embodiments of FIG. 5 may be performed by a CU (e.g., CU as shown and illustrated in FIG. 2). Although described with respect to a CU, it should be understood that other devices may be configured to perform a flowchart similar to that of FIG. 5. Details described in all other embodiments of the present application are applicable for the embodiments of FIG. 5. Moreover, details described in the embodiments of FIG. 5 are applicable for all the embodiments of FIGS. 1-4 and 6-11.

In the exemplary flowchart 500 as shown in FIG. 5, in operation 501, a CU (e.g., CU as shown and illustrated in FIG. 2) may transmit a request to a candidate DU of the BS. The request includes ID information of one or more candidate cells. In operation 502 as shown in FIG. 5, the CU may receive a response corresponding to the request from the candidate DU. The response is associated with a cell switching procedure. In operation 503 as shown in FIG. 5, the CU may transmit configuration information to a UE (e.g., UE 102 as shown and illustrated in FIG. 1) via a source DU of the BS (e.g., DU2 as shown and illustrated in FIG. 2) based on the response.

In some embodiments, the CU may receive further configuration information including at least one of the following from the candidate DU:
(1) a TA value calculated for a TA acquisition procedure or a TA re-acquisition procedure;
(2) ID information of a candidate cell associated with the TA acquisition procedure or the TA re-acquisition procedure, e.g., an index of the candidate cell;
(3) ID information of the UE;
(4) an indication (e.g., indication #4 described in the embodiments of FIG. 4) for indicating the failure of the TA acquisition procedure or the TA re-acquisition procedure;
(5) a request of a measurement result of the UE;
(6) an indication (e.g., indication #5 described in the embodiments of FIG. 4) for indicating the TA re-acquisition procedure; or
(7) RACH configuration information for the TA re-acquisition procedure. Specific examples are described in the embodiments of FIG. 7 or FIG. 8 as follows.

In some embodiments, after receiving the further configuration information from the candidate DU, the CU may transmit the further configuration information to the source DU.

In some embodiments, the CU may receive information (denoted as information #1 for simplicity), which includes at least one of the following, from the source DU:
(1) an indication (denoted as indication #6 for simplicity) for indicating a failure of a TA acquisition procedure or a TA re-acquisition procedure;
(2) ID information of a candidate cell associated with the TA acquisition procedure or the TA re-acquisition procedure; or
(3) a Layer 1 (L1) measurement result of the UE. A specific example is described in the embodiments of FIG. 9 as follows.

In some embodiments, information #1 is received by the source DU from the UE, and then transmitted to the CU.

In some embodiments, the CU may transmit at least one of the following to the candidate DU:
(1) an indication (e.g., indication #3 described in the embodiments of FIG. 4) for indicating the failure of the TA acquisition procedure or the TA re-acquisition procedure; or
(2) the L1 measurement result of the UE.

In some embodiments, the CU may receive failure information related to a TA acquisition procedure or a TA re-acquisition procedure from the UE, and transmit at least one of the following to the candidate DU:
(1) an indication (e.g., indication #3 described in the embodiments of FIG. 4) for indicating a failure of the TA acquisition procedure or the TA re-acquisition procedure; or
(2) a request of RACH configuration information for the TA acquisition procedure or the TA re-acquisition procedure. A specific example is described in the embodiments of FIG. 9 as follows.

FIG. 6 illustrates another exemplary flowchart associated with a cell switching procedure in accordance with some embodiments of the present application. The exemplary flowchart 600 in the embodiments of FIG. 6 may be performed by a source DU (e.g., DU2 or DU1 as shown and illustrated in FIG. 2). Although described with respect to a source DU, it should be understood that other devices may be configured to perform a flowchart similar to that of FIG. 6. Details described in all other embodiments of the present application are applicable for the embodiments of FIG. 6. Moreover, details described in the embodiments of FIG. 6 are applicable for all the embodiments of FIGS. 1-5 and 7-11.

In the exemplary flowchart 600 as shown in FIG. 6, in operation 601, a source DU (e.g., DU2 as shown and illustrated in FIG. 2) may receive configuration information associated with one or more candidate cells related to a cell switching procedure from a CU of the BS. In operation 602, the source DU may transmit further configuration information to a UE based on the configuration information received from the CU in operation 601. In operation 603, the source DU may transmit an indication (e.g., indication #1 as described in the embodiments of FIG. 3) to the UE, to trigger a TA acquisition procedure or a TA re-acquisition procedure to a candidate cell within the one or more candidate cells before performing the cell switching procedure. In an embodiment, the indication is included in DCI (e.g., PDCCH order).

In some embodiments, the configuration information received in operation 601 includes at least one of the following:
(1) a TA value calculated for the TA acquisition procedure or the TA re-acquisition procedure;
(2) ID information of the candidate cell;
(3) ID information of the UE;
(4) an indication (denoted as indication #7 for simplicity) for indicating the TA re-acquisition procedure; or
(5) RACH configuration information for the TA re-acquisition procedure.

In some embodiments, if the configuration information received in operation 601 includes indication #7 and/or the RACH configuration information for the TA re-acquisition procedure, the source DU may transmit an indication (denoted as indication #8 for simplicity) to trigger the TA re-acquisition procedure to a candidate DU of the BS (e.g., DU1 as shown and illustrated in FIG. 2). In some embodiments, the configuration information received in operation 601 is generated by the candidate DU and then transmitted to the CU.

In some embodiments, the source DU may determine whether a TA value is received from a candidate DU of the BS or not within a time period. If the source DU determines that the TA value is not received within the time period, the source DU may determine that the TA acquisition procedure or the TA re-acquisition procedure is failed.

In some embodiments, the source DU may start a timer related to the TA value, and determine that the TA value is not received within the time period upon expiry of the timer. In an embodiment, the timer is started upon transmitting DCI (e.g., a PDCCH order) for the TA acquisition procedure or the TA re-acquisition procedure. In another embodiment, the timer is started in a RO.

In some embodiments, the source DU may receive failure information regarding failing to acquire a TA value from the UE, if the UE fails to receive a TA value after transmitting a preamble (e.g., preamble #1 as described in the embodiments of FIG. 3) for a TA acquisition procedure or a TA re-acquisition procedure to a candidate cell (e.g., candidate cell #1 as described in the embodiments of FIG. 3) once or several times.

In some embodiments, in response to determining that the TA acquisition procedure or the TA re-acquisition procedure is failed or in response to receiving the failure information regarding failing to acquire a TA value from the UE, the source DU may transmit at least one of the following to the CU:
(1) an indication (e.g., indication #6 as described in the embodiments of FIG. 5) for indicating failing to acquire the TA value;
(2) ID information of the first candidate cell; or
(3) a Layer 1 (L1) measurement result of the UE. A specific example is described in the embodiments of FIG. 9 as follows.

In some embodiments, the source DU may receive information, which includes at least one of the following, from the UE:
(1) an indication (denoted as indication #9 for simplicity) for indicating a failure of the TA acquisition procedure or the TA re-acquisition procedure;
(2) ID information of the first candidate cell; or
(3) an L1 measurement result of the UE.

In some embodiments of the present application, the source DU may transmit the received information to the CU. A specific example is described in the embodiments of FIG. 10 as follows.

The following text describes specific embodiments of the flowchart as shown and illustrated in any of FIGS. 3-6. It should be appreciated by persons skilled in the art that the sequence of the operations in any of exemplary flowcharts 700, 800, 900, and 1000 in FIGS. 7-10 may be changed and some of the operations in any of exemplary flowcharts 700, 800, 900, and 1000 in FIGS. 7-10 may be eliminated or modified, without departing from the spirit and scope of the disclosure.

FIG. 7 illustrates an exemplary flowchart of performing a cell change procedure in accordance with some embodiments of the present application. Details described in all other embodiments of the present application are applicable for the embodiments shown in FIG. 7.

As shown in FIG. 7, BS 705 is in CU-DU architecture, and includes CU 704, source DU 702, and candidate DU 703. In the embodiments of FIG. 7, a cell switching operation performed by UE 701 may refer to an Intra-DU case in which a source cell and a target cell in the same DU or refer to an Inter-DU case in which a source cell and a target cell are located at different DUs. For instance, the flowchart 700 as shown in FIG. 7 only shows a cell switching operation in an Inter-DU case for the exemplary purpose. The flowchart 700 also can be applied to an intra-DU case if source DU 702 and candidate DU 703 are the same DU.

In the exemplary flowchart 700 as shown in FIG. 7, in operation 711, UE 701 may access the serving BS (e.g., gNB) and send a measurement report to the serving BS, for example, BS 705. The serving BS may include a CU (e.g., gNB-CU) and one or more DUs (e.g., gNB-DUs). A serving cell is associated with a CU and a DU. There is an F1 interface between the DU and the CU. For example, as shown in FIG. 7, BS 705 includes CU 704, source DU 702, and candidate DU 703. BS 705 may include one or more other candidate DUs (not shown in FIG. 7).

In operation 712, UE 701 receives an RRCReconfiguration message associated with one or more candidate cells for LTM purpose from CU 704 via source DU 702.

In some embodiments, CU 704 determines to initiate L1/L2 based inter-cell mobility configuration. CU 704 may receive a message including the RRCReconfiguration message from candidate DU 703 via an F1 interface. Then, CU 704 may transmit the RRCReconfiguration message from candidate DU 703 to UE 701 via source DU 702 in operation 712.

In some embodiments, if the configuration information transmitted from CU 704 to source DU 702 includes an indication for indicating a TA re-acquisition procedure (e.g., indication #7 as described in the embodiments of FIG. 6) and/or RACH configuration information for the TA re-acquisition procedure, source DU 702 may transmit an indication to trigger the TA re-acquisition procedure (e.g., indication #8 as described in the embodiments of FIG. 6) to candidate DU 703.

In operation 713, UE 701 may receive information (e.g., indication #1 as described in the embodiments of FIG. 3) to trigger a TA acquisition procedure or a TA re-acquisition procedure to a candidate cell within the one or more candidate cells. In some embodiments, the information could be DCI, a MAC CE or RRC signalling. If the information is DCI, it could be a PDCCH order.

In some embodiments, the collision may happen between “UL transmission (e.g., a SR) triggered by UE 701 in the serving cell” and “a RO of a candidate cell for a TA acquisition or re-acquisition procedure triggered by the information received in operation 713”. The RO of the candidate cell may have higher priority than the UL transmission in the serving cell.

In some embodiments, when UE 701 receives a PDCCH order for trigger TA acquisition while UE 701 is initiating a RA procedure in the serving cell, e.g., UL is out of synchronization upon UL data arrival in the serving cell, there may be following two options in different embodiments as below, i.e., Option A and Option B.
(1) Option A: If two RA procedures in parallel are allowed, UE 701 can perform both RA procedures in parallel. However, the RACH occasion may collide between these two RA procedures. If the collision of RACH occasion happens, one of these two RA procedures should be prioritized. For example, a preamble for TA acquisition in the RACH occasion of the candidate cell should be prioritized.
(2) Option B: If two RA procedures in parallel are not allowed, one of these two RA procedures should be prioritized. For example, a preamble for TA acquisition in the RACH occasion of the candidate cell should be prioritized. The RA procedure for UL synchronization in the serving cell of UE 701 can be suspended. UE 701 can continue the RA procedure for UL synchronization in the serving cell when completing the RA procedure for TA acquisition.

In some embodiments, UE 701 may receive multiple PDCCH orders to trigger TA acquisition for the different candidate cells. Once the overlapped RO happens, UE 701 needs to select one. If another TA acquisition fails, UE 701 may report the failure to the source DU 702 or CU 704. The network can trigger to perform TA acquisition again.

In operation 714, UE 701 may transmit the preamble for TA acquisition to candidate DU 703. In some embodiments, UE 701 may transmit the preamble once. In some other embodiments, UE 701 may transmit the preamble several times which can be configured. The times for the preamble transmission can be configured by RRC signalling or a PDCCH order.

In operation 715, if candidate DU 703 successfully receives the dedicated preamble, candidate DU 703 will calculate a TA value.

In operation 716, candidate DU 703 may transmit a message to CU 704 via an F1 interface. The F1 message may include at least one of: the calculated TA value, ID information of the corresponding candidate cell and ID information of UE 701. The F1 message may be a UL RRC MESSAGE TRANSFER message or a UE CONTEXT MODIFICATION REQUEST message.

In operation 717, after CU 704 receives the TA value, CU 704 may transmit the received TA value to source DU 702. In some embodiments, CU 704 may transmit at least one of the TA value, ID information of the corresponding candidate cell or ID information of UE 701 to source DU 702 via CU 704.

In operation 718, source DU 702 may transmit the TA value and the ID information of the corresponding candidate cell to UE 701.

FIG. 8 illustrates a further exemplary flowchart of performing a cell change procedure in accordance with some embodiments of the present application. Details described in all other embodiments of the present application are applicable for the embodiments shown in FIG. 8.

As shown in FIG. 8, BS 805 is in CU-DU architecture, and includes CU 804, source DU 802, and candidate DU 803. In the embodiments of FIG. 8, a cell switching operation performed by UE 801 may refer to an Intra-DU case in which a source cell and a target cell in the same DU or refer to an Inter-DU case in which a source cell and a target cell are located at different DUs. For instance, the flowchart 800 as shown in FIG. 8 only shows a cell switching operation in an Inter-DU case for the exemplary purpose. The flowchart 800 also can be applied to an intra-DU case if source DU 802 and candidate DU 803 are the same DU.

In the exemplary flowchart 800 as shown in FIG. 8, in operation 811, UE 801 may access the serving BS (e.g., gNB) and send a measurement report to the serving BS, for example, BS 805. The serving BS may include a CU (e.g., gNB-CU) and one or more DUs (e.g., gNB-DUs). A serving cell is associated with a CU and a DU. There is an F1 interface between the DU and CU. For example, as shown in FIG. 8, BS 805 includes CU 804, source DU 802, and candidate DU 803. BS 805 may include one or more other candidate DUs (not shown in FIG. 8).

In operation 812, UE 801 receives an RRCReconfiguration message associated with one or more candidate cells for LTM purpose from CU 804 via source DU 802.

In some embodiments, CU 804 determines to initiate L1/L2 based inter-cell mobility configuration. CU 804 may receive a message including the RRCReconfiguration message from candidate DU 803 via an F1 interface. Then, CU 804 may transmit the RRCReconfiguration message from candidate DU 803 to UE 801 via source DU 802.

In some embodiments, if the configuration information transmitted from CU 804 to source DU 802 includes an indication for indicating a TA re-acquisition procedure (e.g., indication #7 as described in the embodiments of FIG. 6) and/or RACH configuration information for the TA re-acquisition procedure, source DU 802 may transmit an indication to trigger the TA re-acquisition procedure (e.g., indication #8 as described in the embodiments of FIG. 6) to candidate DU 803.

In operation 813, UE 801 receives information (e.g., indication #1 described in the embodiments of FIG. 3) to trigger a TA acquisition procedure or a TA re-acquisition procedure to a candidate cell within the one or more candidate cells. In some embodiments, the information could be DCI, a MAC CE or RRC signalling. If the information is DCI, it could be a PDCCH order.

In operation 814, UE 801 may transmit a preamble for the TA acquisition or the TA re-acquisition procedure.

In operation 815, if candidate DU 803 fails to receive a preamble in the configured RO, candidate DU 803 may determine the failure of TA calculation. Then, in operation 816, candidate DU 80 may transmit a message (e.g., message #1 as described in the embodiments of FIG. 4) to CU 804. In an embodiment, the message can be a UL RRC MESSAGE TRANSFER message or a UE CONTEXT MODIFICATION REQUEST message.

The message transmitted in operation 816 may include an indication (e.g., indication #4 as described in the embodiments of FIG. 4) for indicating the failure of TA acquisition or TA re-acquisition and the corresponding RACH configuration (e.g., for a RACH resource). In some embodiments, the RACH configuration for TA acquisition or TA re-acquisition may include at least one of the following:
(1) An RA Preamble index.
(2) An SS/PBCH index. This field may indicate the SS/PBCH that shall be used to determine the RACH occasion for the PRACH transmission.
(3) An RO which is a time-frequency domain resource for preamble transmission.

For instance, a field “PRACH Mask index” to indicate an RACH occasion (RO) associated with the SS/PBCH indicated by “SS/PBCH index” for the PRACH transmission.

In some embodiments, before transmitting the message to CU 804 in operation 816, candidate DU 803 needs to request source DU 802 to provide the latest measurement results via CU 804.

In operation 817, CU 804 may transmit a message including the configuration received from candidate DU 803 to source DU 802. The configuration may include an indication of a TA acquisition or TA re-acquisition procedure (e.g., indication #5 described in the embodiments of FIG. 4) and RACH configuration information for the TA re-acquisition procedure (e.g., the corresponding RACH resource).

In operation 818, source DU 802 will transmit information (e.g., indication #1 as described in the embodiments of FIG. 3) to trigger the TA acquisition or TA re-acquisition procedure to the candidate cell.

In some embodiments, if UE 801 receives a PDCCH order for the same candidate cell (e.g., the PDCCH order includes the cell index), UE 801 may transmit a preamble with higher power compared with the previous transmitted preamble. For example, UE 801 may increase PREAMBLE_POWER_RAMPING_COUNTER by 1.

In operation 819, once source DU 802 decides to execute LTM to a candidate target cell, i.e., to perform a cell switching procedure to the candidate target cell, source DU 802 may transmit a cell switch command, e.g., a MAC CE including candidate cell configuration index, to UE 801 to trigger the cell switching procedure. In some embodiments, the cell switch command, e.g., DCI, a MAC CE or RRC signalling, is used to trigger UE 801 to perform the TA acquisition or TA re-acquisition procedure.

In operation 820, after UE 801 receives the cell switch command from source DU 802, UE 801 may perform the cell switching procedure and synchronize to the candidate target cell, e.g., performing the UL synchronization and/or DL synchronization operations to the candidate target cell.

FIG. 9 illustrates another exemplary flowchart of performing a cell change procedure in accordance with some embodiments of the present application. Details described in all other embodiments of the present application are applicable for the embodiments shown in FIG. 9.

As shown in FIG. 9, BS 905 is in CU-DU architecture, and includes CU 904, source DU 902, and candidate DU 903. In the embodiments of FIG. 9, a cell change of UE 901 may refer to an Intra-DU case in which a source cell and a target cell in the same DU or refer to an Inter-DU case in which a source cell and a target cell are located at different DUs. For instance, the flowchart 900 as shown in FIG. 9 only shows a cell change in an Inter-DU case for the exemplary purpose. The flowchart 900 can be applied to an intra-DU case if source DU 902 and candidate DU 903 are the same DU.

In the exemplary flowchart 900 as shown in FIG. 9, in operation 911, UE 901 may access the serving BS (e.g., gNB) and send a measurement report to the serving BS, for example, BS 905. The serving BS may include a CU (e.g., gNB-CU) and one or more DUs (e.g., gNB-DUs). A serving cell is associated with a CU and a DU. There is F1 interface between the DU and the CU. For example, as shown in FIG. 9, BS 905 includes CU 904, source DU 902, and candidate DU 903. BS 905 may include one or more other candidate DUs (not shown in FIG. 9).

In operation 912, UE 901 receives an RRCReconfiguration message associated with one or more candidate cells for LTM purpose.

In some embodiments, CU 904 may determine to initiate L1/L2 based inter-cell mobility configuration. CU 904 will receive a message including the RRCReconfiguration message from candidate DU 903 via an F1 interface. Then, CU 904 may transmit the RRCReconfiguration message from candidate DU 903 to UE 901 via source DU 902.

In some embodiments, if the configuration information transmitted from CU 904 to source DU 902 includes an indication for indicating a TA re-acquisition procedure (e.g., indication #7 as described in the embodiments of FIG. 6) and/or RACH configuration information for the TA re-acquisition procedure, source DU 902 may transmit an indication to trigger the TA re-acquisition procedure (e.g., indication #8 as described in the embodiments of FIG. 6) to candidate DU 903.

In operation 913, UE 901 receives information (e.g., indication #1 described in the embodiments of FIG. 3) to trigger a TA acquisition procedure or a TA re-acquisition procedure to a candidate cell within the one or more candidate cells. The information could be DCI, a MAC CE or RRC signalling. If the information is DCI, it could be a PDCCH order.

In operation 914, UE 901 may transmit a preamble for the TA acquisition or the TA re-acquisition procedure.

In operation 915, if source DU 902 fails to receive a TA value from the corresponding candidate cell, source DU 902 can determine the failure of TA acquisition.

In some embodiments, source DU 902 may determine the failure of TA acquisition if source DU 902 fails to receive the TA value within a period. In an embodiment, source DU 902 may start a timer upon PDCCH order transmission or RO. Upon expiry of the timer, source DU 902 may determine the failure of TA acquisition.

In operation 916, after source DU 902 determines the failure of TA acquisition, source DU 902 may transmit at least one of the following to CU 904:
(1) An indication of failure of getting the TA value (e.g., indication #6 as described in the embodiments of FIG. 5). The indication may also be named as “an indication of failure of acquiring the TA value” or “an indication for indicating failing to acquire the TA value” or the like. In some embodiments, the indication can be carried in a UL RRC MESSAGE TRANSFER message or a UE CONTEXT MODIFICATION REQUEST message.
(2) ID information of the candidate cell.
(3) A measurement result of UE 901, e.g., an L1 measurement result of UE 901.

In operation 917, CU 904 may transmit an indication of failure of getting TA value (e.g., indication #3 described in the embodiments of FIG. 4) to candidate DU 903. In some embodiments, CU 904 transfers the indication of failure of getting TA value, which is received from source DU 902 in operation 916, to candidate DU 903. In some other embodiments, CU 904 also can determine the failure of TA acquisition, e.g., CU 904 can determine the failure of TA acquisition if CU 904 does not receive a TA value after a period, e.g., upon expiry of a timer. Then, CU 904 transmits the indication of failure of getting TA value to candidate DU 903.

In operation 918, candidate DU 903 may transmit RACH configuration for TA acquisition or TA re-acquisition (e.g., the RACH resource) to source DU 902 via CU 904. In some embodiments, the RACH configuration includes at least one of the following:
(1) an Ra Preamble Index.
(2) An SS/PBCH index. This field may indicate the SS/PBCH that shall be used to determine the RACH occasion for the PRACH transmission.
(3) An RO which is a time-frequency domain resource for preamble transmission. For instance, a field “PRACH Mask index” to indicate an RACH occasion (RO) associated with the SS/PBCH indicated by “SS/PBCH index” for the PRACH transmission.

In operation 919, once source DU 902 decides to execute LTM to a candidate target cell, i.e., to perform a cell switching procedure to the candidate target cell, source DU 902 may transmit a cell switch command, e.g., a MAC CE including candidate cell configuration index, to UE 801 to trigger the cell switching procedure.

In some embodiments, the cell switch command, e.g., DCI, a MAC CE, or RRC signalling, is used to trigger UE 901 to perform the TA acquisition or TA re-acquisition procedure.

In operation 920, after UE 901 receives the cell switch command from source DU 902, UE 901 may perform the cell switching procedure and synchronize to the candidate target cell, e.g., performing the UL synchronization and/or DL synchronization operations to the candidate target cell.

FIG. 10 illustrates another exemplary flowchart of performing a cell change procedure in accordance with some embodiments of the present application. Details described in all other embodiments of the present application are applicable for the embodiments shown in FIG. 10.

As shown in FIG. 10, BS 1005 is in CU-DU architecture, and includes CU 1004, source DU 1002, and candidate DU 1003. In the embodiments of FIG. 10, a cell change of UE 1001 may refer to an Intra-DU case in which a source cell and a target cell in the same DU or refer to an Inter-DU case in which a source cell and a target cell are located at different DUs. For instance, the flowchart 1000 as shown in FIG. 10 only shows a cell change in an Inter-DU case for the exemplary purpose. The flowchart 1000 can be applied to an intra-DU case if source DU 1002 and candidate DU 1003 are the same DU.

In the exemplary flowchart 1000 as shown in FIG. 10, in operation 1011, UE 1001 may access the serving BS (e.g., gNB) and send a measurement report to the serving BS, for example, BS 1005. The serving BS may include a CU (e.g., gNB-CU) and one or more DUs (e.g., gNB-DUs). A serving cell is associated with a CU and a DU. There is F1 interface between the DU and the CU. For example, as shown in FIG. 10, BS 1005 includes CU 1004, source DU 1002, and candidate DU 1003. BS 1005 may include one or more other candidate DUs (not shown in FIG. 10).

In operation 1012, UE 1001 receives an RRCReconfiguration message associated with one or more candidate cells for LTM purpose from CU 1004 via source DU 1002.

In some embodiments, CU 1004 may determine to initiate L1/L2 based inter-cell mobility configuration. CU 1004 will receive the message including the RRCReconfiguration message from the candidate cell via F1 interface. Then, CU 1004 may transmit the RRCReconfiguration message from the candidate cell to UE 1001 via source DU 1002.

In some embodiments, if the configuration information transmitted from CU 1004 to source DU 1002 includes an indication for indicating a TA re-acquisition procedure (e.g., indication #7 as described in the embodiments of FIG. 6) and/or RACH configuration information for the TA re-acquisition procedure, source DU 1002 may transmit an indication to trigger the TA re-acquisition procedure (e.g., indication #8 as described in the embodiments of FIG. 6) to candidate DU 1003.

In operation 1013, UE 1001 receives information (e.g., indication #1 described in the embodiments of FIG. 3) to trigger a TA acquisition procedure or a TA re-acquisition procedure to a candidate cell within the one or more candidate cells. In some embodiments, the information could be DCI (e.g., a PDCCH order), a MAC CE or RRC signalling.

In operation 1014, UE 1001 performs a RA procedure to get a TA value (which may be named as “an early TA value” or the like). In some embodiments, UE 1001 may transmit the preamble once. In some other embodiments, UE 1001 may transmit the preamble several times which can be configured. In addition, the times could be a maximum number of preamble transmissions. Once the maximum number of preamble transmissions is reached and no RAR is received, UE 1001 may consider that the TA acquisition procedure is failed, i.e., the TA acquisition failure.

In some embodiments, the collision may happen between “UL transmission (e.g., a SR) triggered by UE 1001 in the serving cell” and “a RO of a candidate cell for a TA acquisition or re-acquisition procedure triggered by the information received in operation 1013”. The RO of the candidate cell may have higher priority than the UL transmission in the serving cell.

In some embodiments, when UE 1001 receives a PDCCH order for trigger TA acquisition while UE 1001 is initiating a RA in serving cell, e.g., UL is out of synchronization upon UL data arrival in serving cell, there may be following two options in different embodiments as below, i.e., Option X and Option Y.
(1) Option X: If two RA procedures in parallel are allowed, UE 1001 can perform both RA procedures. However, the RACH occasion may collide between these two RA procedures. If the collision of RACH occasion happens, one of these two RA procedures should be prioritized. For example, a preamble for TA acquisition in the RACH occasion of the candidate cell should be prioritized.
(2) Option Y: If two RA procedures in parallel are not allowed, one of these two RA procedures should be prioritized. For example, a preamble for TA acquisition in the RACH occasion of the candidate cell should be prioritized. The RA procedure for UL synchronization in the serving cell of UE 701 can be suspended. UE 701 can continue the RA procedure for UL synchronization in the serving cell when completing the RA procedure for TA acquisition.

In some embodiments, UE 1001 may fail to get the TA value via the RA procedure. For example, UE 1001 does not receive a RAR after transmitting the preamble. After UE 1001 fails to get the TA value via the RA procedure, UE 1001 may report the failure information to the network. In some embodiments, UE 1001 reports the failure information to source DU 1002, e.g., via a MAC CE. In some other embodiments, UE 1001 reports the failure information to CU 1004 via source DU 1002, e.g., via RRC signalling. Then, CU 1004 may indicate at least one of the following: the failure of TA acquisition, or request candidate DU 1003 to update the RACH configuration, e.g., new beam information and measurement result(s). In particular, there may be following two options in different embodiments as below, i.e., Option M and Option N:
(1) Option M: Operations 1015a, 1016a, 1017, 1018, 1019, and 1020 Are Performed.

In operation 1015A, UE 1001 reports the failure information to source DU 1002 via a MAC CE. In operation 1016A, source DU 1002 indicates the failure of the TA acquisition or TA re-acquisition procedure (e.g., indication #9 as described in the embodiments of FIG. 6) to CU 1004 via an F1 interface. The measurement result(s) may be transmitted to CU 1004 together with the failure information. In operation 1017, CU 1004 requests candidate DU 1003 to update the RACH configuration, e.g., new beam information. The measurement result(s) may also transferred to candidate DU 1003. In operation 1018, candidate DU 1003 prepares the new or updated RACH configuration for TA re-acquisition based on the received measurement results and transmits the updated RACH configuration to CU 1004. In operation 1019, CU 1004 transfers the updated RACH configuration to source DU 1002. In operation 1020, after source DU 1002 receives the updated RACH configuration, source DU 1002 transmits an indication for the TA re-acquisition procedure associated with a candidate cell (e.g., indication #2 as described in the embodiments of FIG. 3) to UE 1001. For instance, source DU 1002 transmits a PDCCH order to UE 1001 again in operation 1020
(2) Option N: operations 1015B, 1017, 1018, 1019, and 1020 are performed.

In operation 1015B, UE 1001 reports the failure information to the CU 1004 via RRC signalling. In operation 1017, CU 1004 will transmit at least one of the following to candidate DU 1003: the indication of TA acquisition failure (e.g., indication #3 described in the embodiments of FIG. 4), a request of RACH configuration, or a request of measurement result(s). In operation 1018, candidate DU 1003 prepares the new or updated RACH configuration for TA re-acquisition based on the received measurement results and transmits the updated RACH configuration to CU 1004. In operation 1019, CU 1004 transfers the updated RACH configuration to source DU 1002. In operation 1020, after source DU 1002 receives the updated RACH configuration, source DU 1002 transmits an indication for the TA re-acquisition procedure associated with a candidate cell (e.g., indication #2 as described in the embodiments of FIG. 3) to UE 1001. For instance, source DU 1002 transmits a PDCCH order to UE 1001 again in operation 1020.

In operation 1021, UE 1001 will perform a RA procedure for TA re-acquisition after receiving the PDCCH order from source DU 1002.

In operation 1022, once source DU 1002 decides to execute LTM to a candidate target cell, i.e., to perform a cell switching procedure to the candidate target cell, source DU 1002 may transmit a cell switch command, e.g., MAC CE including candidate cell configuration index, to UE 1001 to trigger the cell switching procedure. In some embodiments, the cell switch command, e.g., DCI, a MAC CE or RRC signalling, is used to trigger UE 1001 to perform the TA acquisition or TA re-acquisition procedure.

In operation 1023, after UE 1001 receives the cell switch command from source DU 1002, UE 1001 may perform the cell switching procedure and synchronize to the candidate target cell, e.g., performing the UL synchronization and/or DL synchronization operations to the candidate target cell.

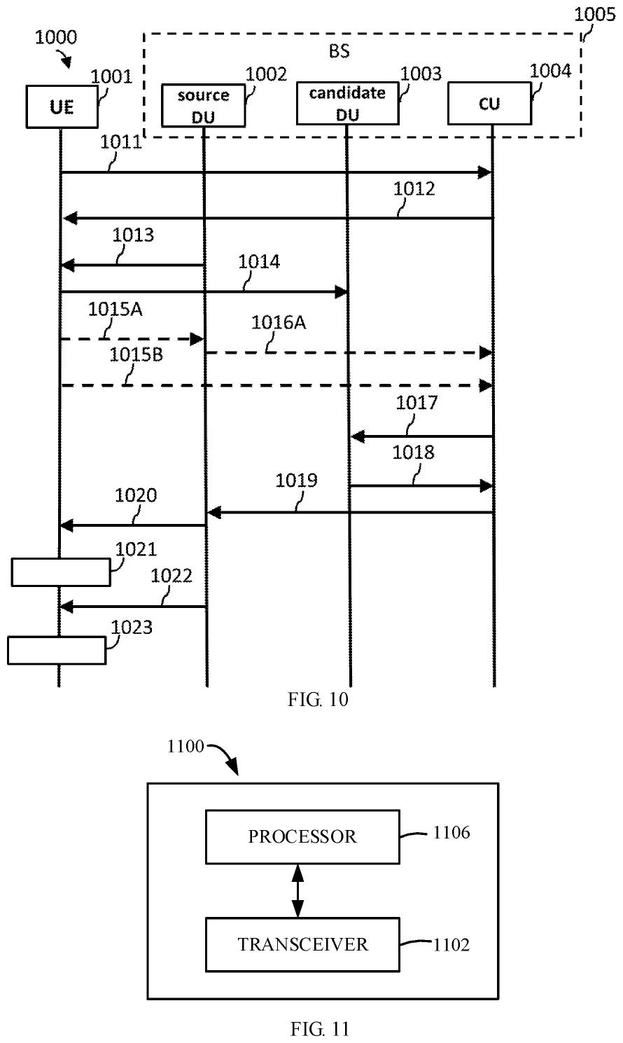

FIG. 11 illustrates a block diagram of an exemplary apparatus 1100 in accordance with some embodiments of the present application. As shown in FIG. 11, the apparatus 1100 may include at least one processor 1106 and at least one transceiver 1102 coupled to the processor 1106. Although in this figure, elements such as the at least one transceiver 1102 and processor 1106 are described in the singular, the plural is contemplated unless a limitation to the singular is explicitly stated. In some embodiments of the subject application, the transceiver 1102 may be divided into two devices, such as a receiving circuitry and a transmitting circuitry. In some embodiments of the subject application, the apparatus 1100 may further include an input device, a memory, and/or other components.

In some embodiments of the subject application, the apparatus 1100 may be a UE or a network node (e.g., a BS, a CU, or a DU). The transceiver 1102 and the processor 1106 may interact with each other so as to perform the operations with respect to the UE or the network node described above, for example, in any of FIGS. 1-10.

In some embodiments of the subject application, the apparatus 1100 may further include at least one non-transitory computer-readable medium. For example, in some embodiments of the present disclosure, the non-transitory computer-readable medium may have stored thereon computer-executable instructions to cause the processor 1106 to implement the method with respect to a UE or a network node (e.g., a BS, a CU, or a DU) as described above. For example, the computer-executable instructions, when executed, cause the processor 1106 interacting with transceiver 1102 to perform the operations with respect to the UE or the network node described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A candidate distributed unit (DU) of a base station,
at least one memory; and
at least one processor coupled with the at least one memory and configured to cause the candidate DU to:
receive a request of a cell switching procedure associated with a candidate cell from a centralized unit (CU) of the base station; and
transmit a response including configuration information associated with the candidate cell to the CU based on the request.

2. The candidate DU of claim 1, wherein the at least one processor is configured to cause the candidate DU to:
receive a preamble for a timing advance (TA) acquisition procedure or a TA re-acquisition procedure;
calculate a TA value based on the received preamble; and
transmit at least one of the TA value, identifier (ID) information of the candidate cell, or
ID information of a user equipment (UE) to the CU.

3. The candidate DU of claim 1, wherein the at least one processor is configured to cause the candidate DU to receive at least one of the following from the CU:
a first indication for indicating a failure of a TA acquisition procedure or a TA re-acquisition procedure;
a request of random access channel (RACH) configuration information for the TA acquisition procedure or the TA re-acquisition procedure; or
a measurement result of a user equipment (UE).

4. The candidate DU of claim 1, in response to failing to receive a preamble for a TA acquisition procedure or a TA re-acquisition procedure in a RACH occasion (RO), the at least one processor is configured to cause the candidate DU to determine a failure of the TA acquisition procedure or the TA re-acquisition procedure.

5. The candidate DU of claim 3, in response to receiving the first indication from the CU or in response to determining the failure of the TA acquisition procedure or the TA re-acquisition procedure, the at least one processor is configured to cause the candidate DU to transmit a first message to the CU, wherein the first message includes at least one of the following:
identifier (ID) information of a candidate cell associated with the TA acquisition procedure or the TA re-acquisition procedure;
ID information of the UE;
a second indication for indicating the failure of the TA acquisition procedure or the TA re-acquisition procedure;
a request of a measurement result of the UE;
a third indication for indicating the TA re-acquisition procedure; or
the RACH configuration information for the TA acquisition procedure or the TA re-acquisition procedure.

6. The candidate DU of claim 1, wherein the response includes a random access channel (RACH) resource for a timing advance (TA) acquisition procedure, and the RACH resource includes a preamble or a RACH occasion (RO).

7. A centralized unit (CU) of a base station, comprising:
at least one memory; and
at least one processor coupled with the at least one memory and configured to cause the CU to:
transmit a request to a candidate distributed unit (DU) of the base station,
wherein the request includes identifier (ID) information of one or more candidate cells;
receive a response corresponding to the request from the candidate DU, wherein
the response is associated with a cell switching procedure; and
transmit first configuration information to a user equipment (UE) via a source DU of the base station based on the response.

8. The CU of claim 7, wherein the at least one processor is configured to cause the CU to receive second configuration information including at least one of the following from the candidate DU:
a timing advance (TA) value calculated for a TA acquisition procedure or a TA re-acquisition procedure; ID information of a candidate cell associated with the TA acquisition procedure or the TA re-acquisition procedure;
ID information of the UE;
a first indication for indicating a failure of the TA acquisition procedure or the TA re-acquisition procedure;
a request of a measurement result of the UE;
a second indication for indicating the TA re-acquisition procedure; or random access channel (RACH) configuration information for the TA re-acquisition procedure.

9. The CU of claim 8, wherein, after receiving the second configuration information from the candidate DU, the at least one processor is configured to cause the CU to transmit the second configuration information to the source DU.

10. The CU of claim 7, wherein the at least one processor is configured to cause the CU to receive second information from the source DU, and wherein the second information includes at least one of the following:
a third indication for indicating a failure of a TA acquisition procedure or a TA re-acquisition procedure;
ID information of a candidate cell associated with the TA acquisition procedure or the TA re-acquisition procedure; or
a Layer 1 measurement result of the UE.

11. The CU of claim 10, wherein the second information is received by the source DU from the UE.

12. The CU of claim 10, the at least one processor is configured to cause the CU to transmit at least one of the following to the candidate DU:
a fourth indication for indicating the failure of the TA acquisition procedure or the TA re-acquisition procedure; or
the Layer 1 measurement result of the UE.

13. The CU of claim 7, wherein the at least one processor is configured to cause the CU to:
receive failure information related to a TA acquisition procedure or a TA re-acquisition procedure from the UE; and
transmit at least one of the following to the candidate DU:
a fifth indication for indicating a failure of the TA acquisition procedure or the TA re-acquisition procedure; or
a request of random access channel (RACH) configuration information for the TA acquisition procedure or the TA re-acquisition procedure.

14. A user equipment (UE), comprising:
at least one memory; and
at least one processor coupled with the at least one memory and configured to cause the UE to:
receive radio resource control (RRC) configuration information associated with one or more candidate cells related to a cell switching procedure; and
receive a first indication to trigger a timing advance (TA) acquisition procedure or a TA re-acquisition procedure to a first candidate cell within the one or more candidate cells before performing the cell switching procedure.

15. The UE of claim claim 14, wherein the at least one processor is configured to cause the UE to:
determine whether a collision happens between an uplink (UL) transmission in a serving cell of the UE and a random access channel occasion (RO) in a candidate cell within the one or more candidate cells, wherein the RO is associated with the TA acquisition procedure or the TA re-acquisition procedure; and
in response to the collision, perform the TA acquisition procedure or the TA re-acquisition procedure associated with the RO.

16. The UE of claim 15, wherein, if the first indication is received while the UE is initiating a first random access (RA) procedure in a serving cell, the at least one processor is configured to cause the UE to:
perform a second RA procedure for the TA acquisition procedure or the TA re-acquisition procedure; or
suspend the first RA procedure.

17. The UE of claim 16, wherein the at least one processor is configured to cause the UE to continue to perform the suspended first RA procedure after completing the second RA procedure.

18. The UE of claim 15, wherein the at least one processor is configured to cause the UE to transmit a first preamble for the TA acquisition procedure or the TA re-acquisition procedure to the first candidate cell once or several times based on the RRC configuration information.

19. The UE of claim 15, wherein the at least one processor is configured to cause the UE to:
receive a second indication for the TA re-acquisition procedure associated with the first candidate cell; and
transmit a second preamble for the TA re-acquisition procedure associated with the first candidate cell with higher power than a first preamble.

20. A processor for wireless communication, comprising:
at least one controller coupled with at least one memory and configured to cause the processor to:
receive radio resource control (RRC) configuration information associated with one or more candidate cells related to a cell switching procedure; and
receive a first indication to trigger a timing advance (TA) acquisition procedure or a TA re-acquisition procedure to a first candidate cell within the one or more candidate cells before performing the cell switching procedure.
